(19) United States
(12) Patent Application Publication
(10) Pub. No.: US 2026/0178437 A1
(43) Pub. Date: Jun. 25, 2026

(54) LOAD BALANCING FOR COMPUTER ERROR ANALYSIS

(71) Applicant: International Business Machines Corporation, Armonk, NY (US)

(72) Inventors: David Michael WALTERS, Manahawkin, NJ (US); Stephanie Carys SHUM, Wappingers Falls, NY (US); David JUN, Nanuet, NY (US); Patrick John CLAS, Pine Plains, NY (US)

(21) Appl. No.: 19/000,431

(22) Filed: Dec. 23, 2024

(51) Int. Cl. G06F 11/07

(52) U.S. Cl. CPC G06F 11/0793; G06F 11/0766

(57) ABSTRACT

In some embodiments, a computer system includes an error manager configured to obtain a first error indication corresponding to a first error associated with a computing device, the first error indication comprising a first error reference code associated with the first error, assign the first error to a first problem analysis window, obtain a second error indication corresponding to a second error associated with the computing device, the second error indication comprising a second error reference code, different from the first error reference code, associated with the second error, assign, based on the second error reference code satisfying an error classification condition, the second error to a second problem analysis window, and perform an error mitigation operation associated with at least one of the first problem analysis window or the second problem analysis window.

### BACKGROUND

The present invention relates to facilitating processing within a computing environment, and for example, relates to load balancing for computer error analysis.

### SUMMARY

In one embodiment, a computer system is provided. In this embodiment, the computer system includes a processor set, one or more computer-readable storage media, and program instructions stored on the one or more computer-readable storage media to cause the processor set to perform operations. The operations include obtaining a first error indication corresponding to a first error associated with a computing device, the first error indication comprising a first error reference code associated with the first error; assigning the first error to a first problem analysis window; obtaining a second error indication corresponding to a second error associated with the computing device, the second error indication comprising a second error reference code, different from the first error reference code, associated with the second error; assigning, based on the second error reference code satisfying an error classification condition, the second error to a second problem analysis window; and performing an error mitigation operation associated with at least one of the first problem analysis window or the second problem analysis window.

In another embodiment, a computer-implemented method is provided. In this embodiment, the method includes obtaining a first error indication corresponding to a first error associated with a computing device, the first error indication comprising a first error reference code associated with the first error; assigning the first error to a first problem analysis window; obtaining a second error indication corresponding to a second error associated with the computing device, the second error indication comprising a second error reference code, different from the first error reference code, associated with the second error; assigning, based on the second error reference code satisfying an error classification condition, the second error to a second problem analysis window; and performing an error mitigation operation associated with at least one of the first problem analysis window or the second problem analysis window.

In yet another embodiment, a computer program product is provided. In this embodiment, the computer program product includes one or more computer-readable storage media and program instructions stored on the one or more computer-readable storage media to perform operations. The operations include obtaining a first error indication corresponding to a first error associated with a computing device, the first error indication comprising a first error reference code associated with the first error; assigning the first error to a first problem analysis window; obtaining a second error indication corresponding to a second error associated with the computing device, the second error indication comprising a second error reference code, different from the first error reference code, associated with the second error; assigning, based on the second error reference code satisfying an error classification condition, the second error to a second problem analysis window; and performing an error mitigation operation associated with at least one of the first problem analysis window or the second problem analysis window.

### BRIEF DESCRIPTION OF THE DRAWINGS

FIG. 1 is a block diagram of an example computing environment described herein.

FIGS. 2A-2C are schematic diagrams showing examples associated with load balancing for computer error analysis described herein.

FIG. 3 is a diagram of an example computing environment in which systems and/or methods described herein may be implemented.

FIG. 4 is a diagram of example components of one or more devices of FIG. 1.

FIG. 5 is a flowchart of an example process associated with load balancing for computer error analysis described herein.

### DETAILED DESCRIPTION

The following detailed description of example implementations refers to the accompanying drawings. The same reference numbers in different drawings may identify the same or similar elements.

In the rapidly evolving landscape of computer systems and networks, error management and analysis have become increasingly critical components of maintaining operational efficiency and reliability. As computing environments grow more complex, with distributed systems, cloud architectures, and interconnected devices, the volume and variety of errors that can occur have expanded exponentially. This proliferation of potential issues presents significant challenges for system administrators and developers tasked with ensuring smooth operations and minimizing downtime.

Traditional approaches to error handling and analysis often rely on single-threaded processing of error logs and notifications. In these systems, when an error occurs, it triggers the creation of a problem analysis window-a designated period during which related errors are collected and analyzed together. This method has been effective in many scenarios, allowing for the grouping of related issues and facilitating root cause analysis. However, as the scale and complexity of computing environments have increased, this single-window approach has begun to show limitations.

One of the primary challenges with the conventional single-window error analysis approach is its inability to efficiently handle multiple, concurrent issues that may be unrelated. In a large-scale system, it is not uncommon for errors to occur simultaneously in different components or subsystems. When these disparate errors are funneled into a single analysis window, it can lead to delays in processing the initial problem and may result in overlooking or misclassifying subsequent, unrelated issues. This situation is particularly problematic in mission-critical systems where rapid identification and resolution of errors are essential.

Furthermore, the single-window approach can become overwhelmed when faced with a high volume of errors, leading to system-wide performance degradation. As the number of errors increases, the analysis process may consume a disproportionate amount of system resources, potentially impacting other critical functions. In extreme cases, this can result in the system becoming unresponsive or unable to process new errors, leaving it vulnerable to cascading failures. Additionally, the backlog of unprocessed errors can lead to significant delays in identifying and addressing critical issues, potentially exacerbating the impact of system failures.

Another limitation of current error analysis systems is their inability to effectively prioritize and categorize errors in real-time. Without a sophisticated mechanism for distinguishing between different types of errors and their potential impact, all issues are treated with equal priority. This lack of differentiation can result in critical errors being buried among less significant issues, delaying their resolution and potentially leading to more severe system failures. Moreover, the absence of intelligent error classification hampers the system's ability to learn from past incidents and improve its error handling capabilities over time.

Implementations of this disclosure may address problems such as these by devising multiple analysis windows designated to handle groups of errors projected to be related. An error manager may obtain a first error indication corresponding to a first error associated with a computing device, where the first error indication comprises a first error reference code associated with the first error. The first error may then be assigned to a first problem analysis window. Subsequently, the error manager may obtain a second error indication corresponding to a second error associated with the computing device, where the second error indication comprises a second error reference code, different from the first error reference code, associated with the second error. Based on the second error reference code satisfying an error classification condition, the second error may be assigned to a second problem analysis window. As used herein, a “problem analysis window” refers to a designated time period and processing resources allocated for analyzing and grouping related errors. For example, a problem analysis window may be opened for hardware-related errors, while a separate window may be used for software-related issues.

An “error manager” may refer to a software component, a hardware component, or a combination thereof configured to detect, analyze, and process errors in a computing environment. These functionalities may collectively facilitate maintaining system stability and performance by iteratively identifying, understanding, and resolving issues that arise during system operations. Such an error manager may employ a variety of techniques for error detection, analysis, and processing, often customized to address the unique requirements of specific computing environments.

The detection phase may include the use of system monitoring techniques to identify anomalies or unexpected behaviors across hardware and software components. For instance, system logs may be scanned to identify error messages, warnings, or unusual patterns, while performance monitoring tools may track CPU usage, memory consumption, network traffic, and other system metrics for deviations from established baselines. In distributed computing environments, heartbeat checks may ensure the responsiveness of services, while exception-handling mechanisms may capture and log errors triggered by application code. Additional detection mechanisms may include analyzing sensor data for abnormal readings in IoT systems, examining network traffic for malformed packets, or monitoring database queries and API responses for performance anomalies or failures.

The analysis phase may involve investigating the underlying causes, impact, and potential solutions for detected errors. Techniques used in this phase may include error classification by type or severity, pattern recognition to identify recurring issues, and root cause analysis to trace issues back to their triggers. In certain scenarios, historical data comparison and dependency mapping may be used to identify correlations between system components and errors, while performance profiling tools may help isolate inefficiencies in code execution. Machine learning algorithms can further assist in detecting anomalies or predicting future issues, and visualization techniques such as heatmaps or graphs may simplify error data interpretation for system administrators.

Error processing may encompass various remediation strategies designed to mitigate, resolve, or prevent errors. For instance, automated error-handling mechanisms may be implemented to address recurring issues, while rollback procedures may revert the system to a stable state following critical failures. Resource allocation adjustments and load balancing can address performance-related errors, while patch management ensures that known vulnerabilities or bugs are resolved. Failover mechanisms may enhance resilience by switching to redundant components during hardware failures, and detailed error reports and user notifications may improve situational awareness and response coordination. Continuous monitoring ensures that resolved errors do not recur, while call home operations provide important insights into system health and facilitate remote error resolution.

A call home operation typically involves packaging information about the system's current state, recent errors, and diagnostic data into a structured format, such as a log file or telemetry data packet. The information may include error codes, stack traces, performance metrics, and system configuration details. Once packaged, this data may be securely transmitted to a central monitoring service or technical support system, often using encrypted channels to ensure confidentiality and integrity. Upon receipt, the central service can analyze the data, correlate it with other reports, and initiate appropriate corrective actions, such as sending configuration updates, recommending patches, or dispatching a support technician. By automating this process, call home operations facilitate proactive error management and reduce downtime in distributed environments.

By way of example, consider a web application hosted on a distributed cloud infrastructure. The error manager may detect anomalies such as increased response times by monitoring API interactions and comparing them against historical data. Upon identifying the anomaly, it may classify the error as a performance bottleneck and perform root cause analysis, revealing that a specific database query is running slower than expected due to a high volume of requests. To address the issue, the error manager may trigger a rollback to a previously optimized database configuration and dynamically allocate additional system resources to handle the surge in traffic. A call home operation may then package information about the detected anomaly, the applied corrective actions, and the current system state, transmitting it to a central monitoring service for further evaluation and record-keeping.

In another example, an IoT system managing a network of smart sensors may rely on the error manager to monitor sensor data for abnormal readings, such as temperature spikes outside expected ranges. If an anomaly is detected, the error manager may cross-reference historical data to identify patterns suggesting potential hardware degradation. Following this analysis, the error manager may trigger a failover to redundant sensors while notifying administrators and scheduling a maintenance update. Simultaneously, a call home operation may compile a detailed diagnostic report, including sensor metadata, error patterns, and operational logs, and transmit it to a remote support center. This proactive approach may facilitate early detection of systemic issues, ensuring minimal disruption to the IoT network.

Implementations of this disclosure may address problems such as these by utilizing historical data and machine learning techniques to create and continually learn error groupings. The error manager may analyze log files for prior defects to determine what reference codes were included in previous analysis windows and if any additional defects were opened for any of the reference codes within those windows. This analysis may help establish relationships between errors and improve the accuracy of error classification over time. The term “reference code” encompasses various identifiers associated with errors, such as error codes, log entries, or unique identifiers generated by the system. For instance, a reference code may be an alphanumeric string that indicates the type of error, its severity, and the component in which it occurred.

Implementations of this disclosure may address problems such as these by implementing dynamic load balancing for error analysis. When a problem analysis window becomes overwhelmed, additional windows for related errors may be opened, ensuring proper load balancing. The error manager may determine that a quantity of unprocessed errors associated with a problem analysis window exceeds an unprocessed error count threshold. Based on this determination, a new problem analysis window corresponding to the same problem may be opened, and subsequent related errors may be assigned to this new window. “Load balancing” in this context refers to the distribution of error processing tasks across multiple analysis windows to optimize resource utilization and minimize processing delays. Alternative embodiments may include predictive opening of analysis windows based on historical data, such as anticipated high-load periods or known system vulnerabilities.

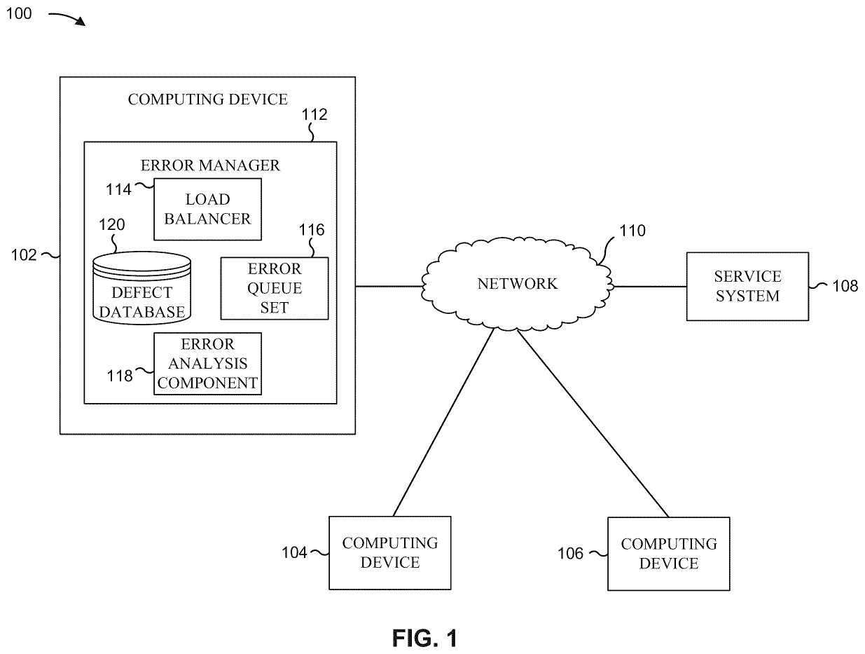

FIG. 1 illustrates a block diagram of a computing environment 100 for managing and analyzing errors. The computing environment 100 includes a computing device 102, additional computing devices 104 and 106, a service system 108, and a network 110 connecting these components.

Any one or more of the computing devices 102, 104, and 106 may encompass a wide range of computing systems and architectures. In some aspects, these devices may be part of a cloud computing infrastructure, which may include public, private, or hybrid cloud environments. Cloud computing devices may include virtualized resources, such as virtual machines or containers, running on physical hardware in data centers. In some implementations, the computing devices 102, 104, and 106 may be based on mainframe architectures, such as IBM z/Architecture systems. These systems may be designed for high-volume transaction processing and may include features like redundant components for high availability and reliability. Mainframe systems may be particularly suited for handling large-scale error management tasks due to their robust error detection and recovery capabilities.

The computing devices 102, 104, and 106 may include distributed systems, such as those based on microservices architectures. In these systems, applications may be broken down into smaller, independent services that communicate over a network. This architecture may allow for more granular error detection and management at the individual service level. In some implementations, the computing devices 102, 104, and 106 may be edge computing nodes, which process data closer to the source of data generation. These devices may be responsible for initial error detection and triage before communicating with centralized systems for more comprehensive analysis.

The computing devices 102, 104, and 106 may include specialized hardware accelerators, such as Graphics Processing Units (GPUs) or Field-Programmable Gate Arrays (FPGAs), which may be used for specific error analysis tasks that require high computational power, such as pattern recognition in large datasets of error logs. In Internet of Things (IOT) scenarios, the computing devices may include embedded systems or single-board computers that are part of a larger network of sensors and actuators. These devices may have limited resources but may play a role in detecting and reporting errors at the edge of the network. In some implementations, the computing devices 102, 104, and 106 may include mobile devices, such as smartphones or tablets, which may act as both sources of error data and interfaces for system administrators to monitor and manage errors remotely.

The computing device 102 contains an error manager 112, which is responsible for handling and processing errors. The error manager 112 may be implemented as software running on the computing device 102, as a dedicated hardware component, or as a combination of hardware and software. In some embodiments, the error manager 112 may be distributed across multiple devices or implemented as a cloud-based service.

Within the error manager 112, there are several subcomponents: a load balancer 114, an error queue set 116, an error analysis component 118, and a defect database 120. These components work together to provide a technical solution for efficient error management and analysis.

The load balancer 114 is designed to distribute incoming errors across the error queue set 116, which may contain multiple queues for different types of errors. The load balancer 114 may use various algorithms to determine the optimal distribution of errors, such as round-robin, least connections, or weighted distribution based on error types. In some implementations, the load balancer 114 may employ machine learning techniques to adapt its distribution strategy based on historical data and system performance.

The error queue set 116 may consist of multiple queues, each dedicated to specific types of errors or components of the system. For example, there might be separate queues for hardware errors, software errors, network errors, and performance-related issues. The use of multiple queues allows for parallel processing of errors and helps prevent a single type of error from overwhelming the entire system. The queues may be organized based on problem analysis windows.

As used herein, a “problem analysis window” may refer to a designated portion of a queue or processing resource allocated for analyzing and grouping related errors within a specified time frame. In the context of a queue, a problem analysis window may represent a subset of error entries that are processed together based on shared characteristics or temporal proximity. This approach may allow for efficient categorization and resolution of similar issues, while also enabling parallel processing of distinct error types. Problem analysis windows may be dynamically adjusted in size or duration based on factors such as error frequency, severity, or system load, potentially improving overall error management efficiency.

The error analysis component 118 processes the errors in the queues. In some implementations, the error analysis component 118 may use information stored in the defect database 120 to assist in the analysis. The error analysis component 118 may employ various analysis techniques, such as pattern recognition, statistical analysis, or machine learning algorithms to identify the root causes of errors and suggest potential solutions. In some embodiments, the error analysis component 118 may also prioritize errors based on their severity and potential impact on the system.

The defect database 120 stores historical information about past errors, their causes, and resolutions. This database may be implemented using various database technologies, such as relational databases, NoSQL databases, or graph databases, depending on the specific requirements of the system. The defect database 120 may facilitate improving the accuracy and efficiency of error analysis over time.

The network 110 may encompass a wide range of communication technologies and architectures to facilitate data exchange between the various components of the computing environment. In some implementations, the network 110 may include traditional wired networks, such as Ethernet-based local area networks (LANs) or fiber optic networks for high-speed, long-distance data transmission. These wired networks may provide reliable, high-bandwidth connections suitable for data-intensive error management tasks. Wireless technologies may also be incorporated into the network 110. For instance, Wi-Fi networks may enable flexible connectivity within office environments or data centers, while cellular networks, including 4G LTE or 5G, may support mobile devices or remote sensors in IoT scenarios. In some cases, the network 110 may leverage satellite communication systems to provide connectivity in remote or hard-to-reach locations.

The network 110 may employ software-defined networking (SDN) principles, allowing for dynamic, programmatic network configuration to optimize data flow for error management processes. This approach may enable more efficient routing of error-related data and adaptive network resource allocation based on current system needs. In some implementations, the network 110 may incorporate edge computing principles, with localized processing nodes positioned closer to data sources. This architecture may reduce latency for time-sensitive error detection and initial triage, while still allowing for centralized analysis and management. The network 110 may also include virtual private networks (VPNs) or other secure tunneling protocols to ensure the confidentiality and integrity of error-related data as it traverses public internet infrastructure. In some cases, dedicated leased lines or multiprotocol label switching (MPLS) networks may be used for mission-critical error management systems requiring guaranteed bandwidth and low latency.

For IoT-based error management scenarios, the network 110 may incorporate low-power wide-area network (LPWAN) technologies such as LoRaWAN or NB-IoT, enabling efficient communication with distributed sensors and devices while minimizing power consumption. In cloud-based implementations, the network 110 may leverage content delivery networks (CDNs) or cloud front-end services to optimize the distribution of error management resources and reduce latency for geographically dispersed systems. The network 110 may also include specialized industrial networks such as PROFINET or EtherCAT for error management in manufacturing or process control environments, providing deterministic communication for real-time error detection and response.

In some cases, the network 110 may employ blockchain or distributed ledger technologies to create a tamper-resistant record of error occurrences and resolutions, potentially enhancing the reliability and traceability of error management processes. The network 110 may also incorporate advanced traffic management techniques, such as quality of service (QoS) policies, to prioritize error-related data flows and ensure timely processing of critical errors even during periods of high network congestion.

The service system 108 may provide additional services or support for error management and analysis. This could include advanced analytics, machine learning models, or expert systems to assist in diagnosing complex errors. In some implementations, the service system 108 may also provide updates to the error manager 112 or the defect database 120 based on new knowledge or patterns discovered across multiple systems.

The computing devices 104 and 106 are connected to the network 110 and may generate errors that are sent to the computing device 102 for processing. These devices could represent various types of systems that are being monitored for errors, such as servers, workstations, mobile devices, or Internet of Things (IoT) devices. In some embodiments, the computing devices 104 and 106 may have their own local error detection and preliminary analysis capabilities before sending error indications to the computing device 102.

One of the advantages of this error manager 112 is its ability to handle a high volume of errors from diverse sources without becoming overwhelmed. By using multiple problem analysis windows, as implemented through the error queue set 116 and managed by the load balancer 114, the error manager 112 can process errors in parallel, reducing the likelihood of bottlenecks and potentially ensuring that critical errors are not delayed due to an influx of less severe issues. The error manager 112 also provides flexibility in how errors are classified and processed. For example, the error classification condition used by the load balancer 114 to assign errors to different queues may be based on various factors, such as error type, category (e.g., software issue, performance issue, resource issue, or hardware issue), or similarity to known error patterns. This classification can be dynamically adjusted based on the current state of the system and historical data. Furthermore, the error manager 112 may be designed to adapt to changing conditions. If a particular problem analysis window becomes overwhelmed, the error manager 112 may open additional windows to handle the increased load. This dynamic allocation of resources helps ensure that the error manager remains responsive even during periods of high error volume or when dealing with particularly complex issues.

As indicated above, FIG. 1 is provided as an example. Other examples may differ from what is described with regard to FIG. 1. The number and arrangement of devices shown in FIG. 1 are provided as an example. There may be additional devices (e.g., a large number of devices), fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

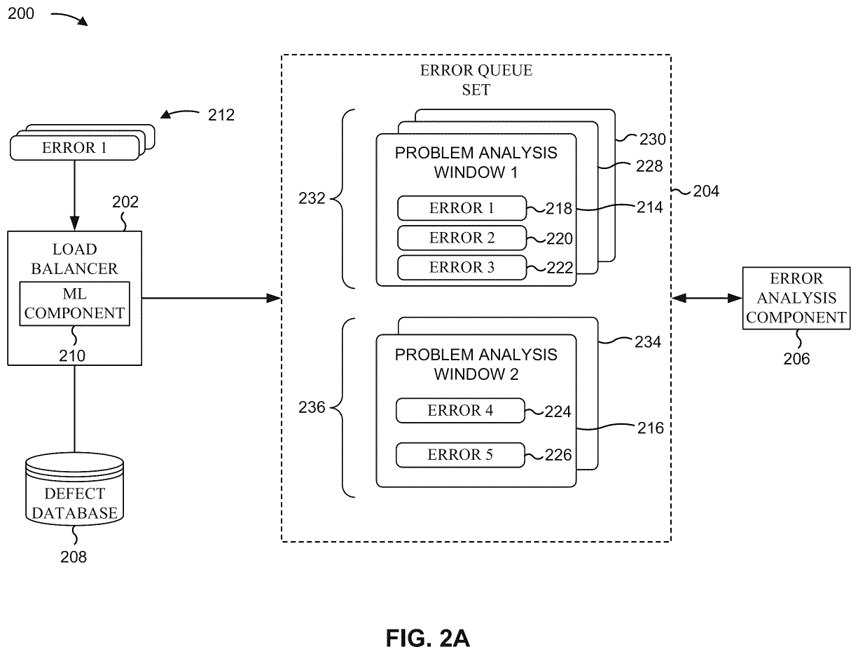

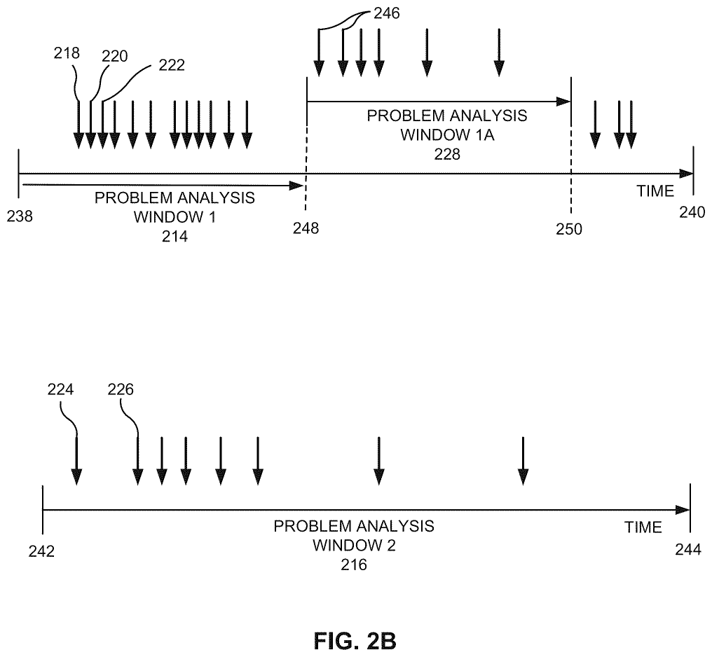

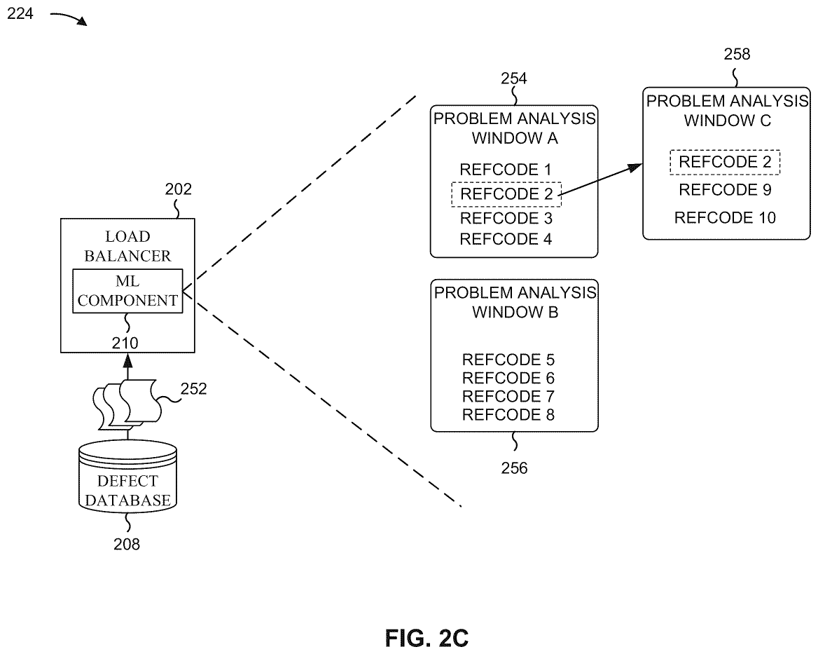

FIGS. 2A-2C are schematic diagrams showing examples associated with load balancing for computer error analysis described herein. FIG. 2A illustrates a block diagram of an error manager 200. The error manager 200 includes several components that work together to process and analyze error indications. These components include a load balancer 202 configured to manage an error queue set 204, an error analysis component 206 configured to analyze errors based on the error queue set 204, and a defect database 208. The load balancer 202 contains a machine learning (ML) component 210 that may assist in distributing errors to appropriate problem analysis windows.

An ML component refers to software and/or hardware capable of performing ML. ML is a subset of artificial intelligence (AI) that involves the development of algorithms and statistical models enabling computers to perform tasks without explicit programming. ML leverages large datasets to identify patterns, make decisions, and improve over time based on experience. ML focuses on creating systems that can learn from data, adapt to new inputs, and generate predictions or actions.

For example, an ML component may be or include one or more ML models, ML algorithms, and/or ML systems including combinations of ML algorithms and ML models. An ML component may be implemented on any number of different hardware devices and may include one or more machine learning models. ML is a field of study that gives computers the ability to perform certain tasks without being explicitly programmed to perform those tasks. In traditional computing, a programmer would encode instructions (e.g., to solve a quadratic equation using the quadratic formula), and the computer would perform those exact instructions. In contrast, in ML, a computer can be provided with examples and be trained to perform a task such as prediction or classification, without the programmer encoding explicit instructions for the task. ML explores the study and construction of algorithms, also referred to herein as tools, models, and/or components, which may learn from existing data and make predictions about new data. Such ML tools operate by building a model from example training data in order to make data-driven predictions or decisions expressed as outputs or assessments. Although example embodiments are presented with respect to a few ML models, the principles presented herein may be applied to other ML models. In some example embodiments, different ML models may be used. ML models may include, for example, K-means clustering models, linear regression models, logistic regression (LR) models, Naive-Bayes models, random forest (RF) regression models, gradient boost models, neural networks (NN), matrix factorization models, large language models (LLMs), and/or support vector machines (SVMs), among other examples.

In operation, the error manager 200 receives error indications 212, which are directed to a load balancer 202. The load balancer 202 may open, within an error queue set 204, a problem analysis window 1 214 and a problem analysis window 2 216. As shown, based on the error indications 212, the load balancer 202 may assign errors to appropriate problem analysis windows. For example, as shown, the load balancer 202 may assign an error 1 218, an error 2 220, and an error 3 222 to the problem analysis window 1 214. In addition, the load balancer 202 may assign an error 4 224 and an error 5 226 to the problem analysis window 2 216.

The load balancer 202 may access the defect database 208 when classifying and allocating errors. In some implementations, the load balancer 202 may use defect descriptions stored in the defect database 208 to assist in determining appropriate problem analysis windows for processing, as described in more detail below in conjunction with FIGS. 2B and 2C.

In some implementations, the load balancer 202 may open additional problem analysis windows when processing the queued errors. For example, as shown in FIG. 2A, the load balancer 202 may open a problem analysis window 1A 228 and a problem analysis window 1B 230, which may be open in parallel with the problem analysis window 2 216. The problem analysis windows 1 214, 1A 228, and 1B 230 may be grouped in the error queue set 204 as a window group 232. Similarly, the load balancer 202 may open a problem analysis window 2A 234. The problem analysis windows 2 216 and 2A 234 may also be grouped in the error queue set 204 as a window group 236.

FIG. 2B illustrates a system diagram of problem analysis windows for error processing. As shown, the problem analysis window 1 214 may be defined by a start time 238 and an end time 240. The problem analysis window 2 216 may be defined by a start time 242 and an end time 244. As the load balancer 202 obtains error indications, it assigns the errors respectively, as shown by the downward pointing arrows. In these assignments, error 1 218, error 2 220, and error 3 222 are assigned to problem analysis window 1 214. Similarly error 4 224 and error 5 226 are assigned to problem analysis window 2 216.

To assign errors to problem analysis windows, the load balancer 202 may obtain error reference codes from the error indications 212. Based on an error classification condition associated with the error reference codes, the error reference codes may be assigned to a problem analysis window. The error classification condition may depend on various factors, including error type, category (e.g., software issue, performance issue, resource issue, or hardware issue), or similarity to known error patterns. In some implementations, the error classification condition used by the load balancer 202 may dynamically adjust over time based on changes to the system and/or historical data.

In some implementations, the error reference codes may be assigned to problem analysis windows based on a hierarchy of issue types. For example, error reference codes corresponding to hardware issues may be assigned to the problem analysis window 1 214. Error reference codes corresponding to software issues may be assigned to the problem analysis window 2 216. Further, error reference codes corresponding to resource-related issues may be assigned to a different problem analysis window (e.g., problem analysis window 228), while error reference codes corresponding to performance-related issues may be assigned to yet another problem analysis window.

In some implementations, the error reference codes may be assigned to problem analysis windows based on a reference code similarity value that measures the relative similarity between the error reference codes and one or more known error patterns. In some implementations, a reference code similarity value may be a numeric or textual indication of the extent to which two error reference codes are similar to known issues associated with the system. For example, if two error reference codes both correspond to the same hardware error, they may be assigned to the same problem analysis window. In contrast, if one of the error reference codes corresponds to a hardware error and the other error reference code corresponds to a software issue, they may be assigned to different problem analysis windows.

The reference code similarity value may be determined using various methods. In one implementation, this may involve analyzing error logs associated with corresponding problem analysis windows, employing techniques to categorize error reference codes as similar or dissimilar. The determination of the similarity value may occur at multiple levels of granularity, including, for example, log class, log type, and reference code extension.

The levels of granularity used to compute the similarity measure between reference codes may include log class, which identifies the specific component of the system exhibiting a failure; log type, which further specifies the area of code within that component; and reference code extensions, which provide additional details such as the specific failure, the affected hardware, or other relevant information. Using this hierarchical structure, the system may associate similar errors by prioritizing various factors in descending order of significance. For instance, the highest priority may be assigned to errors with matching reference codes and extensions, followed by errors with matching reference codes, then errors sharing the same log class and type, and finally, errors that match at the log class level alone.

In addition to these primary similarity factors, secondary factors may also influence the computation of similarity between reference codes. These secondary factors may include comments in linked defect records, where the system may tokenize the comments to extract meaningful keywords related to specific components, areas, filenames, or additional reference codes. These keywords may then be vectorized using techniques such as bag of words or term frequency-inverse document frequency (tf-idf) and compared using similarity metrics such as cosine similarity or Jaccard similarity. Another secondary factor may involve the area against which the error is filed, with a matching area increasing the similarity score, while a mismatch decreases it. Similarly, the system may account for personnel assigned to the error, granting higher similarity to errors assigned to the same individual or team, and lower similarity for unrelated assignments. Tags or keywords associated with the errors may also contribute to the similarity calculation, with exact matches or synonyms increasing similarity, while antonyms or unrelated tags decrease it.

By analyzing these factors, a reference code similarity value may be calculated for each incoming error. This similarity value may then be used to assign the error to an appropriate problem analysis window. For example, if an incoming error exhibits a high similarity value with errors in a specific analysis window, the system may assign the error to that window. This process enables the system to efficiently organize and group related errors, thereby facilitating targeted problem analysis and resolution.

In one illustrative scenario, an incoming error log may be processed to identify a log class associated with a database component, a log type specifying query execution, and a reference code extension indicating a timeout failure. The system may analyze these factors and determine a high similarity value with an existing problem analysis window containing errors related to database query timeouts. Additionally, comments from linked defect records and tags referencing the same database module may further reinforce the similarity calculation, resulting in the error being assigned to the relevant window. This assignment process enables systematic aggregation and prioritization of similar issues for streamlined resolution efforts.

The system may also use this similarity analysis to create groupings of reference codes. If a reference code starts a window and other reference codes occur that don't result in an additional defect, the system may create a many-to-many mapping of these related reference codes. This mapping may be stored and used for future error assignments, potentially improving the efficiency of the error classification process over time.

Furthermore, the system may use the reference code similarity determination process to include known related reference codes in a window. For example, if the system identifies that certain reference codes are frequently related based on historical data, it may preemptively include these in the same problem analysis window when one of them occurs. This automation may reduce or eliminate the need for human involvement and help ensure that relevant issues are processed quickly and efficiently.

As shown in FIG. 2B, the load balancer 202 may open a problem analysis window 1A 228 in response to certain conditions within the error management system. For example, the problem analysis window 1A 228 may be opened when the number of errors assigned to problem analysis window 1 214 reaches a predetermined threshold. This threshold may be based on factors such as the processing capacity of the error analysis component, the complexity of the errors being analyzed, or the time elapsed since the opening of window 1 214. The opening of window 1A 228 may allow for more efficient distribution and processing of incoming errors 246, potentially preventing bottlenecks in the error analysis process. In some implementations, window 1A 228 may be configured to handle specific types of errors or errors from particular sources, complementing the error processing capabilities of window 1 214. The start time 248 of window 1A 228 may overlap with the time period of window 1 214, allowing for seamless transition and continuity in error processing.

In some implementations, the problem analysis window 1A 228 may be closed, at a closing time 250, after a predetermined time period has elapsed. The predetermined time period may be determined based on a type of error, based on how the system is (e.g., a load of the system), among other examples.

FIG. 2C is a schematic diagram associated with assigning errors to problem analysis windows based on an analysis of log files. As shown, the load balancer 202 may access log files 252 maintained in the defect database 208. Using these log files 252, the load balancer 202 may determine what reference codes were included in previous analysis windows and if any additional defects were opened for any of the reference codes within those windows. For example, log files 252 may be used to determine that a new problem analysis window is to be opened for a reference code that was incorrectly included in an analysis window it is not related to and, accordingly, was included in the call home data for a problem that the reference code was not related to.

As shown, a prior problem analysis window A 254 contains REFCODE 1, REFCODE 2, REFCODE 3, and REFCODE 4. A prior problem analysis window B 256 contains REFCODE 5, REFCODE 6, REFCODE 7, and REFCODE 8. A prior problem analysis window C 258 contains REFCODE 2, REFCODE 9, and REFCODE 10. The diagram shows an arrow from REFCODE 2 in prior problem analysis window A 254 to prior problem analysis window C 258, indicating that REFCODE 2 was open in both windows. Based on this analysis, the load balancer 202 may determine that REFCODE 2 is not associated with the reference codes in the prior problem analysis window A 254. This is because the load balancer 202 may have previously classified REFCODE 2 as a problem distinct from what is contained in prior problem analysis window A 254, causing the load balancer 202 to create a new problem analysis window containing REFCODE 2 (prior problem analysis window C 258).

Similarly, the load balancer 202 may base a reference code classification on the lack of an additional prior problem analysis window. For example, if REFCODE 1, REFCODE 3, and REFCODE 4 have no additional prior problem analysis window, the load balancer 202 may conclude that REFCODE 1, REFCODE 3, and REFCODE 4 are similar and should be classified in a same window. Accordingly, the load balancer 202, when obtaining an error indication corresponding to a reference code in the prior problem analysis window A 254, may assign the corresponding error to a new problem analysis window that corresponds to the prior problem analysis window A 254.

According to various implementations, the load balancer 202 may use any number of other factors to determine an appropriate problem analysis window for a given error. In some implementations, the load balancer may use a combination of the analysis techniques described in FIGS. 2A-2C, or other techniques.

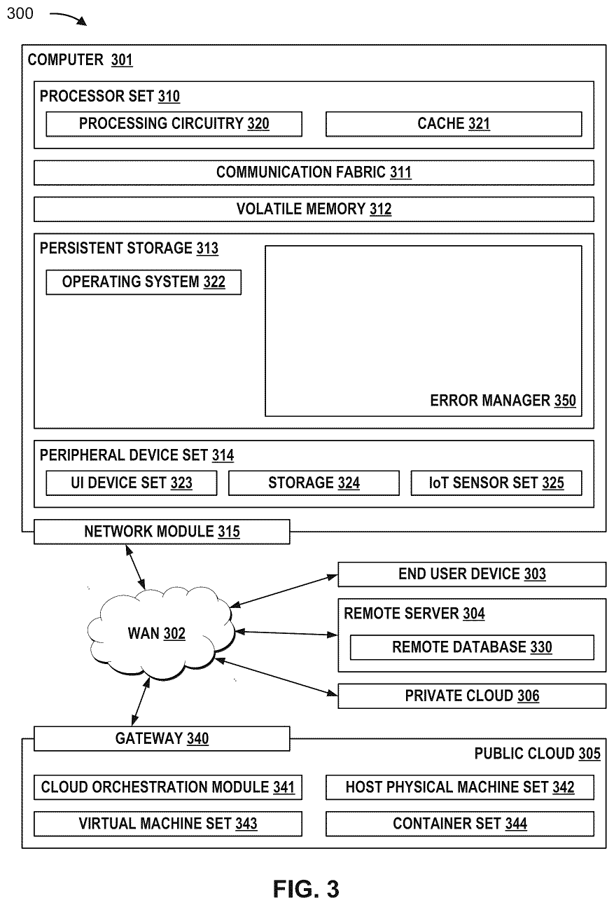

FIG. 3 is a diagram of an example computing environment 300 in which systems and/or methods described herein may be implemented. Various aspects of the present disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called “mediums”) collectively included in a set of one, or more, storage devices that collectively include machine readable code corresponding to instructions and/or data for performing computer operations specified in a given claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code involved in performing the inventive methods, such as a load balancer, shown in block 350. In addition to block 350, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and block 350, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

COMPUTER 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

PROCESSOR SET 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in block 350 in persistent storage 313.

COMMUNICATION FABRIC 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

PERSISTENT STORAGE 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in block 350 typically includes at least some of the computer code involved in performing the inventive methods.

PERIPHERAL DEVICE SET 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

NETWORK MODULE 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

REMOTE SERVER 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

PUBLIC CLOUD 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

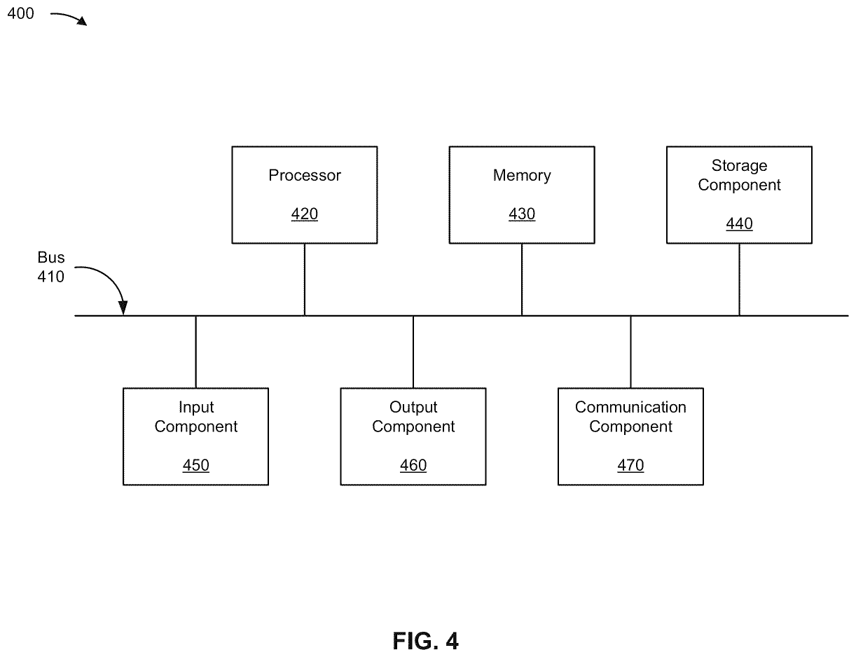

FIG. 4 is a diagram of example components of a device 400, which may implement one or more components of the computing environment 100. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, and/or an actuator. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, and/or an antenna.

Device 400 may perform one or more processes described herein. For example, a non-transitory computer-readable medium (e.g., memory 430 and/or storage component 440) may store a set of instructions (e.g., one or more instructions, code, software code, and/or program code) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

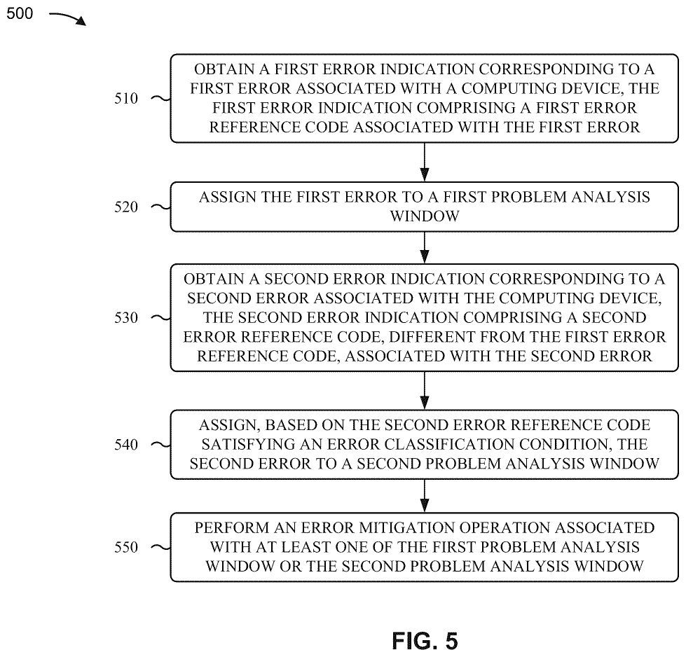

FIG. 5 is a flowchart of an example process 500 associated with load balancing for computer error analysis as described herein. In some implementations, one or more process blocks of FIG. 7 may be performed by an error manager (e.g., the error manager 112 or the error manager 200). Additionally, or alternatively, one or more process blocks of FIG. 5 may be performed by one or more components of device 400, such as processor 420, memory 430, storage component 440, input component 450, output component 460, and/or communication component 470.

As shown in FIG. 5, process 500 may include obtaining a first error indication corresponding to a first error associated with a computing device, the first error indication comprising a first error reference code associated with the first error (block 510). For example, the error manager may obtain a first error indication corresponding to a first error associated with a computing device, the first error indication comprising a first error reference code associated with the first error, as described above.

As shown in FIG. 5, process 500 may include assigning the first error to a first problem analysis window (block 520). For example, the error manager may assign the first error to a first problem analysis window, as described above.

As shown in FIG. 5, process 500 may include obtaining a second error indication corresponding to a second error associated with the computing device, the second error indication comprising a second error reference code, different from the first error reference code, associated with the second error (block 530). For example, the error manager may obtain a second error indication corresponding to a second error associated with the computing device, the second error indication comprising a second error reference code, different from the first error reference code, associated with the second error, as described above.

As shown in FIG. 5, process 500 may include assigning, based on the second error reference code satisfying an error classification condition, the second error to a second problem analysis window (block 540). For example, the error manager may assign, based on the second error reference code satisfying an error classification condition, the second error to a second problem analysis window, as described above.

In some implementations, process 500 includes determining that the second error reference code satisfies the error classification condition based on an error type associated with the second error reference code. In some implementations, process 500 includes determining that the second error reference code satisfies the error classification condition based on a category associated with the second error reference code. In some implementations, the category may include at least one of a software issue, a performance issue, a resource issue, or a hardware issue. In some implementations, process 500 includes determining that the second error reference code satisfies the error classification condition based on a comparison of the second error reference code with the first error reference code.

In some implementations, process 500 includes determining a reference code similarity value associated with the second error reference code and a third error reference code assigned to the second problem analysis window; and determining that the second error reference code satisfies the error classification condition based on the reference code similarity value.

In some implementations, process 500 includes accessing a system log associated with the computing device; determining, based on the system log, that the first error reference code was assigned to a first prior problem analysis window; determining, based on the system log, that the second error reference code was assigned to a second prior problem analysis window; and determining, based on the first error reference code being assigned to the first prior problem analysis window and the second error reference code being assigned to the second prior problem analysis window, that the second error reference code satisfies the error classification condition.

In some implementations, process 500 includes obtaining a third error indication corresponding to a third error associated with the computing device, the third error indication including a third error reference code, different from the first error reference code and the second error reference code, associated with the third error; determining, based on the system log, that the third error reference code was assigned to the first prior problem analysis window; determining, based on the system log, that the third error reference code was assigned to the second prior problem analysis window; determining, based on the third error reference code being assigned to the first prior problem analysis window and the second error reference code being assigned to the second prior problem analysis window, that the third error reference code fails to satisfy the error classification condition; and assigning, based on the third error reference code failing to satisfy the error classification condition, the third error to the first problem analysis window.

In some implementations, process 500 includes obtaining a third error indication corresponding to a third error associated with the computing device, the third error indication including a third error reference code different from the second error reference code; determining, based on the system log, that the third error reference code was assigned to the first prior problem analysis window; and assigning, based on the third error reference code being assigned to the first prior problem analysis window, the third error to the first problem analysis window.

In some implementations, the first problem analysis window corresponds to a first problem and the second problem analysis window corresponds to a second problem, and the process 500 includes obtaining a third error indication comprising a third error reference code corresponding to a third error, where the third error is associated with the first problem; determining that a quantity of unprocessed errors associated with the first problem analysis window exceeds an unprocessed error count threshold; opening, based on the quantity exceeding the unprocessed error count threshold, a third problem analysis window corresponding to the first problem; and assigning, based on the third problem analysis window being opened, the third error to the third problem analysis window. In some implementations, process 500 includes determining that an updated quantity of unprocessed errors associated with the third problem analysis window is less than the unprocessed error count threshold; and closing, based on the updated quantity being less than the unprocessed error count threshold, the third problem analysis window.

In some implementations, process 500 includes determining the error classification condition using a machine learning component.

In some implementations, process 500 includes detecting an occurrence of a window opening trigger; and opening, based on the window opening trigger, a third problem analysis window. In some implementations, the window opening trigger may be associated with a user request. In some implementations, the window opening trigger may be associated with at least one of a change in an operating status of the computing device, a change in a configuration parameter associated with the computing device, or a change in a processing resource associated with the computing device. In some implementations, the window opening trigger may be associated with an external event.

As shown in FIG. 5, process 500 may include performing an error mitigation operation associated with at least one of the first problem analysis window or the second problem analysis window (block 550). For example, the error manager may perform an error mitigation operation associated with at least one of the first problem analysis window or the second problem analysis window, as described above.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer system comprising:
a processor set;
one or more computer-readable storage media; and
program instructions stored on the one or more computer-readable storage media to cause the processor set to perform operations comprising:
obtaining a first error indication corresponding to a first error associated with a computing device, the first error indication comprising a first error reference code associated with the first error;
assigning the first error to a first problem analysis window;
obtaining a second error indication corresponding to a second error associated with the computing device, the second error indication comprising a second error reference code, different from the first error reference code, associated with the second error;
assigning, based on the second error reference code satisfying an error classification condition, the second error to a second problem analysis window; and
performing an error mitigation operation associated with at least one of the first problem analysis window or the second problem analysis window.

2. The computer system of claim 1, the operations further comprising:
determining that the second error reference code satisfies the error classification condition based on an error type associated with the second error reference code.

3. The computer system of claim 1, the operations further comprising:
determining that the second error reference code satisfies the error classification condition based on a category associated with the second error reference code.

4. The computer system of claim 3, wherein the category comprises at least one of a software issue, a performance issue, a resource issue, or a hardware issue.

5. The computer system of claim 4, the operations further comprising:
determining that the second error reference code satisfies the error classification condition based on a comparison of the second error reference code with the first error reference code.

6. A computer-implemented method, comprising:
obtaining a first error indication corresponding to a first error associated with a computing device, the first error indication comprising a first error reference code associated with the first error;
assigning the first error to a first problem analysis window;
obtaining a second error indication corresponding to a second error associated with the computing device, the second error indication comprising a second error reference code, different from the first error reference code, associated with the second error;
assigning, based on the second error reference code satisfying an error classification condition, the second error to a second problem analysis window; and
performing an error mitigation operation associated with at least one of the first problem analysis window or the second problem analysis window.

7. The computer-implemented method of claim 6, further comprising:
determining that the second error reference code satisfies the error classification condition based on an error type associated with the second error reference code.

8. The computer-implemented method of claim 6, further comprising:
determining that the second error reference code satisfies the error classification condition based on a category associated with the second error reference code, wherein the category comprises at least one of a software issue, a performance issue, a resource issue, or a hardware issue.

9. The computer-implemented method of claim 6, further comprising:
determining a reference code similarity value associated with the second error reference code and a third error reference code assigned to the second problem analysis window; and
determining that the second error reference code satisfies the error classification condition based on the reference code similarity value.

10. The computer-implemented method of claim 6, further comprising:
accessing a system log associated with the computing device;
determining, based on the system log, that the first error reference code was assigned to a first prior problem analysis window;
determining, based on the system log, that the second error reference code was assigned to a second prior problem analysis window; and
determining, based on the first error reference code being assigned to the first prior problem analysis window and the second error reference code being assigned to the second prior problem analysis window, that the second error reference code satisfies the error classification condition.

11. The computer-implemented method of claim 10, further comprising:
obtaining a third error indication corresponding to a third error associated with the computing device, the third error indication comprising a third error reference code, different from the first error reference code and the second error reference code, associated with the third error;
determining, based on the system log, that the third error reference code was assigned to the first prior problem analysis window;
determining, based on the system log, that the third error reference code was assigned to the second prior problem analysis window;
determining, based on the third error reference code being assigned to the first prior problem analysis window and the second error reference code being assigned to the second prior problem analysis window, that the third error reference code fails to satisfy the error classification condition; and
assigning, based on the third error reference code failing to satisfy the error classification condition, the third error to the first problem analysis window.

12. The computer-implemented method of claim 10, further comprising:
obtaining a third error indication corresponding to a third error associated with the computing device, the third error indication comprising a third error reference code different from the second error reference code;
determining, based on the system log, that the third error reference code was assigned to the first prior problem analysis window; and
assigning, based on the third error reference code being assigned to the first prior problem analysis window, the third error to the first problem analysis window.

13. The computer-implemented method of claim 6, wherein the first problem analysis window corresponds to a first problem and the second problem analysis window corresponds to a second problem, further comprising:
obtaining a third error indication comprising a third error reference code corresponding to a third error, wherein the third error is associated with the first problem;
determining that a quantity of unprocessed errors associated with the first problem analysis window exceeds an unprocessed error count threshold;
opening, based on the quantity exceeding the unprocessed error count threshold, a third problem analysis window corresponding to the first problem; and
assigning, based on the third problem analysis window being opened, the third error to the third problem analysis window.

14. The computer-implemented method of claim 13, further comprising:
determining that an updated quantity of unprocessed errors associated with the third problem analysis window is less than the unprocessed error count threshold; and
closing, based on the updated quantity being less than the unprocessed error count threshold, the third problem analysis window.

15. The computer-implemented method of claim 6, further comprising:
determining the error classification condition using a machine learning component.

16. A computer program product comprising:
one or more computer-readable storage media; and
program instructions stored on the one or more computer-readable storage media to perform operations comprising:
obtaining a first error indication corresponding to a first error associated with a computing device, the first error indication comprising a first error reference code associated with the first error;
assigning the first error to a first problem analysis window;
obtaining a second error indication corresponding to a second error associated with the computing device, the second error indication comprising a second error reference code, different from the first error reference code, associated with the second error;
assigning, based on the second error reference code satisfying an error classification condition, the second error to a second problem analysis window; and
performing an error mitigation operation associated with at least one of the first problem analysis window or the second problem analysis window.

17. The computer program product of claim 16, the operations further comprising:
detecting an occurrence of a window opening trigger; and
opening, based on the window opening trigger, a third problem analysis window.

18. The computer program product of claim 17, wherein the window opening trigger is associated with a user request.

19. The computer program product of claim 17, wherein the window opening trigger is associated with at least one of a change in an operating status of the computing device, a change in a configuration parameter associated with the computing device, or a change in a processing resource associated with the computing device.

20. The computer program product of claim 17, wherein the window opening trigger is associated with an external event.
